(19) United States
(12) Patent Application Publication
(10) Pub. No.: US 2010/0062407 A1
(43) Pub. Date: Mar. 11, 2010

(54) Device And Methods For Medical Training Using Live Subjects

(76) Inventor: Paul Jacques Charles Lecat, Tallmadge, OH (US)

Correspondence Address: Emerson, Thomson & Bennett, LLC, 777 W. Market Street, Akron, OH, 44303, US

(21) Appl. No.: 12/207,033

(22) Filed: Sep. 9, 2008

(51) Int. Cl. G09B 23/28

(52) U.S. Cl. 434/262

(57) ABSTRACT

The present invention generally relates to devices and methods for training medical personnel. Some embodiments of the present invention relate to a medical training device, comprising: at least one modular component, the component comprising a means for mounting the modular component to a portion of a healthy live subject; a means for simulating one or more physiological attributes; and a means for controlling the simulation.

The present application claims priority to U.S. Provisional Patent Application Ser. No. 61/102,971 filed on Jan. 28, 2008 now pending, which is hereby incorporated by reference in its entirety.

### I. BACKGROUND OF THE INVENTION

A. Field of Invention

The present invention generally relates to devices and methods for training medical personnel.

B. Description of the Related Art

Training of medical students and related personnel relies on conducting realistic simulations of various situations that such person may encounter in a clinical setting. Traditionally, simulations have been conducted through the use of reusable mannequins, and disposable or semi-disposable task trainers. Mannequins are adapted to present one or more of a variety of issues to the trainee and can be reused repeatedly. Task trainers are devices that are designed to present a well defined problem that the trainee can cut, inject, suture, etc. Such devices are generally either disposable or have a more limited life than a mannequin. Training simulations that exclude live human subjects lack the element of human interaction that can be very important in a real clinical environment. Accordingly, some simulations involve the use of live human actors rather than mannequins or task trainers.

Using live human subjects is also problematic because, although they are able to interact with the trainee, the trainee is not able to engage in some activities that would be available with a mannequin or task trainer. For example, the trainee could not actually inject, cut or suture an actor, or provide real chest compressions or the like. Furthermore, in many respects, the live human subject does not present realistic symptoms such as heart rate, blood pressure and the like. Thus, traditional simulation means for training medical personnel are deficient and are incapable of realistically simulating many situations.

Some embodiments of the present invention provide improvements over and additions to the prior art.

### II. SUMMARY OF THE INVENTION

Some embodiments of the present invention relate to a medical training device, comprising: at least one modular component, the component comprising a means for mounting the modular component to a portion of a healthy live subject; a means for simulating one or more physiological attributes; and a means for controlling the simulation.

Other embodiments relate to a medical training device, comprising: at least one modular simulation component, the component comprising a mounting member adapted to mount the modular component to a portion of a healthy live subject; a simulation unit incorporated on or in the mounting member and adapted to mimic one or more physiological attributes; and at least one controller unit in electronic communication with the simulation unit and adapted to control the operation of the simulation unit, wherein the controller unit can be onboard the modular simulation component or disposed remotely from the modular simulation component.

Still other embodiments relate to a process for training medical personnel, comprising the steps of: causing a live subject to mimic at least one predetermined physiological attribute; and electronically controlling the at least one mimicked physiological attribute.

Other benefits and advantages will become apparent to those skilled in the art to which it pertains upon reading and understanding of the following specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a flowchart showing a process embodiment;

FIG. 2 is a drawing showing an audible simulation embodiment;

FIG. 3 is a drawing of a pulse simulation embodiment;

FIG. 4 is a drawing of a audible blood flow simulation embodiment;

FIG. 5 is a drawing of a pulse simulation embodiment mounted on a live subject;

FIG. 6 is a drawing of a vest embodiment having simulation units in the chest area;

FIG. 7 is a flowchart illustrating the operation of a transmitter embodiment;

FIG. 8 is a flowchart showing the operation of a receiver embodiment in connection with an audible simulation;

FIG. 9 is a schematic diagram of a transmitter circuit embodiment; and

FIG. 10 is a schematic diagram of a receiver circuit embodiment.

### IV. DETAILED DESCRIPTION OF THE INVENTION

The present invention generally relates to devices, systems and methods for simulating attributes of live subjects for the purpose of medical training. The attributes simulated may be healthy, normal or pathological in nature. Furthermore, according to some embodiments, a simulation device is mountable on a live subject.

According to one embodiment, the present invention comprises a device having a means for mounting the device to a live subject, a means for simulating one or more physiological attributes, and a means for controlling the simulation.

A mounting means can comprise any of a variety of structures appropriate for mounting a device to a live subject. For example, in some embodiments the mounting means can comprise a sleeve, sock, stocking, girdle, shirt, vest, mitten, glove, adhesive sheet, strap, band, harness, belt, tie, tether, and the like, or any combination thereof. Furthermore, such structures can be made from a wide variety of materials depending on the requirements of the specific simulation. Some appropriate materials can include one or more of thermoform polymers, thermoset polymers, pliable polymers, rigid polymers, and elastomers. Some specific polymer materials include latex, nitrile rubber, carboxylated nitrile rubber, ethylene/methylacrylate copolymers, styrene butadiene rubber, neoprene, natural rubber, silicone, SANTOPRENE (registered trademark of Advanced Elastomer Systems of Akron Ohio), fluoroelastomers, vinylidene fluoride and perfluoro-propylene copolymer, polyurethanes, chlorosulfonated polyethylene, polychloroprene, isoprene, isoneoprene, isobutylene isoprene, acetonitrile butadiene, EPDM (ethylene proplylene diene monomer), and the like, and any derivative, copolymer, blend or combination thereof. One of skill in the art will recognize that a wide variety of other polymer materials are within the scope of the present invention.

According to some embodiments a means for simulating a physiological attribute can comprise a wide variety of devices and methods depending upon the specific attribute being simulated. For example, a venous or arterial pulse could be simulated by means such as, but not limited to, pneumatic, hydraulic, electromechanical, or by liquid pressure. In other embodiments the means for simulating can comprise an acoustic output such as an electric speaker device or other device capable of producing appropriate acoustic waves. Still other means for simulation can include heating devices for simulating body heat. In some embodiments color-change materials, such as electrochromic materials, can be included for simulating tissue discoloration. Electroactive materials can be used in some embodiments for simulating a wide variety of physiological attributes including, without limitation, pupillary size, muscle tone, blood pressure, pulmonary function, venous and/or arterial pulses, reflexes and the like and any combination thereof.

In some embodiments appropriate electroactive materials can include dielectric electroactive polymers, such as electrorestrictive polymers and/or dielectric elastomers. Some specific materials that can be appropriate in some embodiments include, without limitation, polymethylmethacrylate-based electrorestrictive polymers. Other materials include, without limitation, silicone-based and/or acrylic-based dielectric elastomers. One specific acrylic polymer is VHB 4910, which is available commercially from Minnesota Mining and Manufacturing. Some embodiments can include ionic electroactive polymers such as, without limitation, polyacetylenes, polypyroles, polyanalines, or any derivative or combination thereof.

According to some embodiments, a means for controlling a simulation can comprise any of a wide variety of digital or analog electronic circuits, as would be apparent to one of skill in the art. According to some embodiments, the means for controlling can include digital processor control. Furthermore, the controller can be adapted to actuate the simulation device according to a predetermined pattern of time, voltage, current and the like or any combination thereof. According to some embodiments, a controller can be adapted to alter and/or adjust the simulation according one or more of feedback data, a predetermined program or process, or operator input. In some embodiments, the controller can be disposed on board the simulation unit, or can control the unit remotely through electrical wiring, fiber optic cable, or wireless communications, or any combination thereof.

In some embodiments at least a portion of the controller electronics can be disposed in a handheld unit. For instance, such a handheld unit might be used by an instructor or human subject to trigger the simulation of selected physiological attributes. A handheld unit can include a hardwire connection to a main controller unit and/or a simulation module. Alternatively, the handheld unit can include one or more means for wireless communication with a main controller and/or simulation module.

Some embodiments can be adapted to simulate one or more of a variety of physiological attributes including, but not limited to, blood pressure, blood flow, jugular pulses, venous pulses, heart beats, any of a wide variety of pathological or healthy heart sounds, heart murmurs, sounds related to pulmonary function, body heat, tissue exudates, internal or external bleeding, skin or eye discoloration, pupillary size, and the like or any combination thereof.

One embodiment comprises a modular unit that includes a strap-on device for simulating a pulse in the human wrist. In this embodiment, the pulse simulation can comprise a pneumatically formed pulse of air or other fluid being delivered to an elastomeric cavity with a pneumatic or hydraulic source such as a pump. According to this embodiment, the elastomeric cavity receives the pulse of air or other fluid and stiffens or expands in response to the increase in pressure, thus forming the high-pressure end of the simulated pulse. The pressure can be decreased according to a variety of means including, but not limited to, one or more of, disengaging and/or de-energizing the pneumatic source, or by providing one or more vents for the pressurized gas in the elastomeric cavity. In some embodiments a vent can comprise an appropriately sized orifice in fluid communication with the ambient atmosphere. In other embodiments a vent can include one or more valves. The valves can be adapted to be actuated according to a predetermined program so as to cause periodic decreases in pressure. According to some embodiments, the device is electronically connectable to, and in electronic communication with, a remote controller device.

Some embodiments comprise a plurality of modules worn by a single live subject. In some embodiments, each module is adapted to simulate one or more physiological attributes. For example, a live subject may wear a first module for selectively simulating one or more heart sounds, and a second module for simulating blood pressure. The same live subject may also wear additional modules to simulate other physiological attributes. In some embodiments each module can be controlled by the same or different controller. Furthermore, some embodiments include controllers having the capacity to adjust the simulation of one or more modules in response to the output of one or more other modules. For instance, the blood pressure module may simulate a different blood pressure depending on the type of sound simulated by the heart sounds module.

According to some embodiments, modules may be adapted to respond to human interactions including, but not limited to, drug injections, electric shock, physiologic shock, hemorrhage, chest compressions and the like, or any combination thereof. For instance, a heart sounds module may also be adapted to sense injections, defibrillator shocks, and/or chest compressions, which can be fed back to the controller unit. The controller unit can then adjust the heart sounds and blood pressure simulations in response to the sensed activity.

The present invention can be used in connection with any of a variety of organisms including humans. However, some embodiments can be directed to veterinary training. Thus, some embodiments may be constructed for use with specific species and may be sized and programmed accordingly. Alternatively, the present invention can be used in connection with an existing mannequin, for instance, by strapping one or more modules to the mannequin.

In some embodiments one or more simulation units can comprise a part of a mannequin rather than a module that can be attached to a mannequin. For instance, a pupillary size simulator can comprise a model eye that includes a pupil made at least partially from an electroactive polymer capable of expanding and contracting in response to an electronic control signal. Similarly, a mannequin can include artificial muscle comprised of electroactive polymer for simulating muscle tone and/or reflexes.

Some embodiments can include a glove, or glove-like device, worn by a student, which simulates tactile examination. In some embodiments such a device creates a tactile simulation according to the position of the glove relative to the mannequin. For example, if the tip of one or more fingers of the glove is in contact with a simulated artery of the mannequin, then the glove may generate a simulated pulse that can be tactilely sensed by a wearer of the glove. One of skill in the art will recognize that a wide variety of means for producing a tactilely perceptible simulated pulse exist and can be adapted for use in such a glove-like device. Some such means have already been described in this disclosure. According to some embodiments, a tactile examination simulator glove can comprise a glove-like structure having a means for producing a tactilely perceptible signal. The means for producing can be in electronic controlling communication with one or more controller units. In some embodiments a controller unit can be adapted to detect the position of the glove relative to one or more tactile examination zones on the mannequin. According to some embodiments the tactilely perceptible signal can respond to one or more parameters such as, without limitation, pressure applied by the glove to the mannequin, or data from other parts of the mannequin. For instance, according to a simulated cardiac condition, the student may feel a strong pulse, a weak pulse, and irregular pulse or no pulse at all.

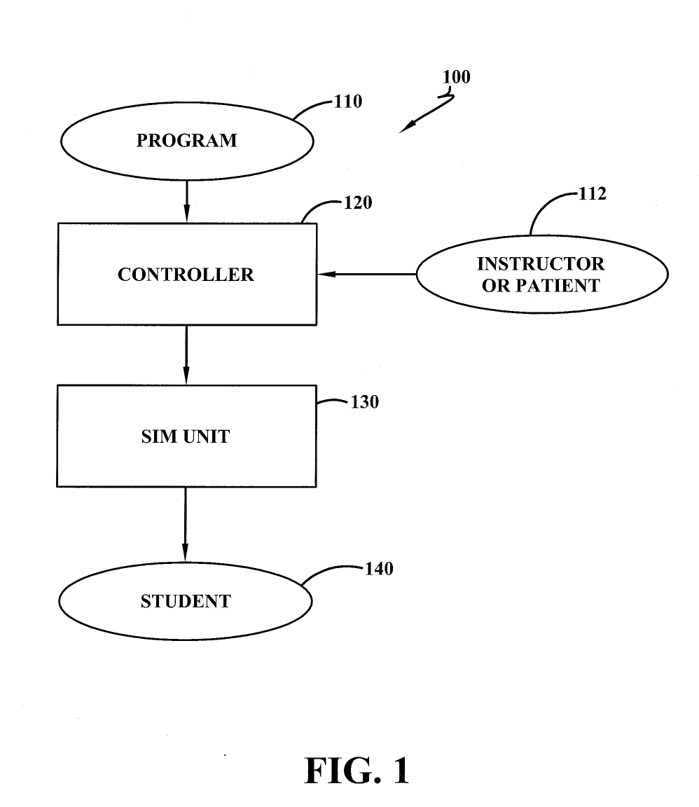

Referring now to the drawings wherein the showings are for purposes of illustrating embodiments of the invention only and not for purposes of limiting the same, FIG. 1 is a flow chart showing a process 100 of the present invention. According to FIG. 1 controller 120 takes instructions from one or more of a program 110 and an instructor and/or patient 112. The controller interprets the commands to control the functioning of a simulation unit 130. The student 140 interacts with the simulation unit. In some embodiments the actions of the student result in signals that are fed back to the controller 120 and can be interpreted by the program 110 and/or instructor 112, which can adjust the simulation according to the feedback signal received.

FIG. 2 is a drawing of an embodiment comprising a portion of an audio simulation unit 200. According to FIG. 2 the embodiment includes a sound-producing device such as a speaker 220. The speaker 220 is embedded in a polymeric matrix 210 capable of transmitting at least a portion of the sound produced by the speaker 220 so that the sound can be detected, for instance, with a stethoscope or other listening device, or with the unaided human ear. The speaker 220 is shown in electrical communication with a controller unit 230 through a hard-wired connection 240. The controller 230 can include a computer program for controlling the speaker 220. The controller 230 can also, or alternatively, include one or more human interface controls providing an instructor with a means for altering and/or monitoring the simulation.

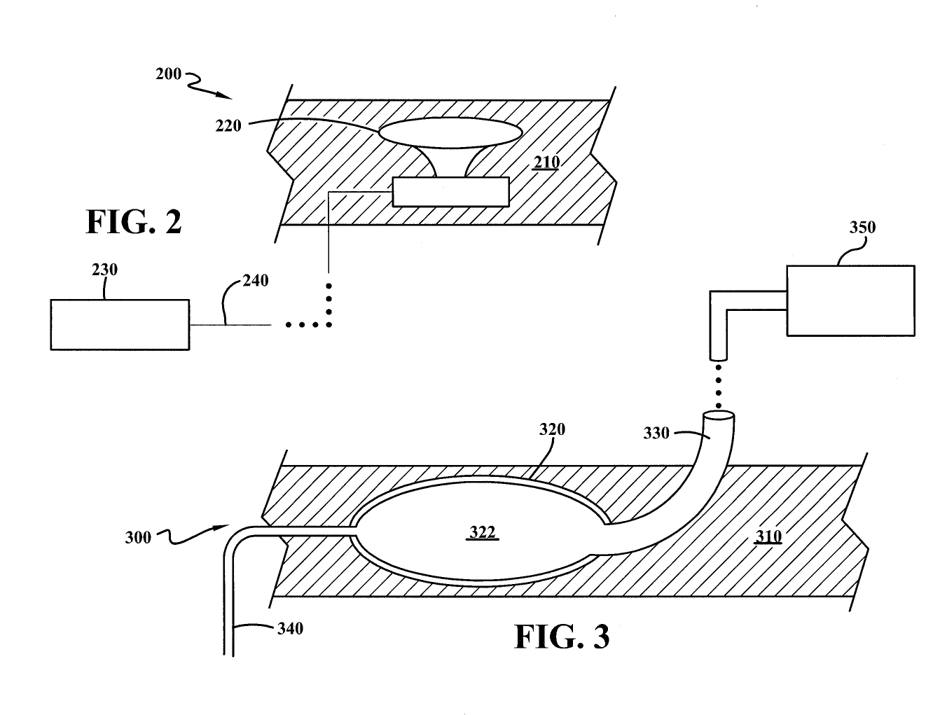

FIG. 3 is a drawing of an embodiment comprising a pulse simulator 300. According to FIG. 3, the embodiment includes a bladder 320 formed in a polymeric matrix 310. The bladder 320 can comprise a cavity 322 defined by the polymer matrix 310, or can comprise a separate structure embedded in the polymer matrix 310. According to FIG. 3 the bladder 320 includes a larger diameter intake tube 330 and a smaller diameter effluent tube 340. Pump 350 is in fluid communication with the bladder 320 through the larger diameter tube 330. Furthermore, pump 350 is adapted to receive electronic instructions from a controller unit (not shown). Therefore, pump 350 can be actuated according to a predetermined pattern to deliver pressure pulses to bladder 320. Since effluent tube 340 is significantly smaller in diameter than intake tube 330 fluid collects in cavity 322 and causes the bladder 320 to expand. Such expansion can be detected by a student and perceived as a pulse.

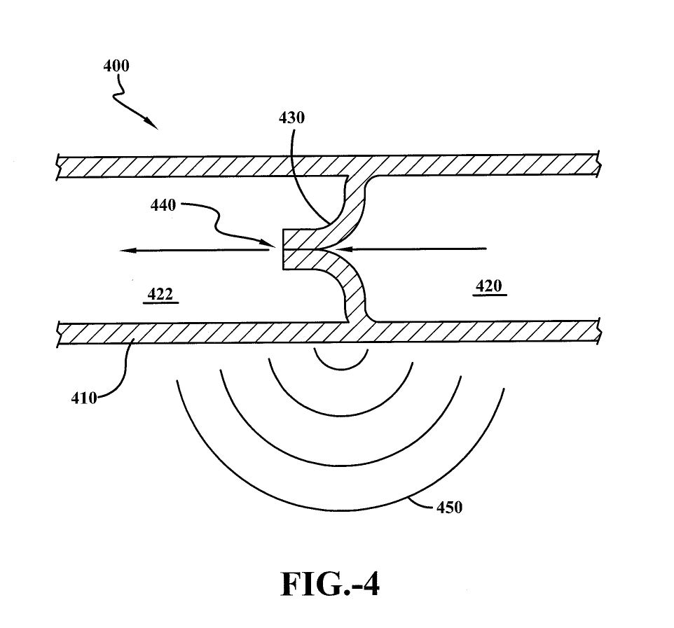

FIG. 4 is a drawing of an embodiment comprising a pulse and/or blood flow simulation device 400. According to FIG. 4 this embodiment includes a vessel wall 410 defining a generally cylindrical shape, which simulates a blood vessel wall. The vessel wall 410 can be made from any appropriate elastomeric material. The embodiment also includes a valve wall 430 defining a one-way valve and dividing the interior of vessel 410 into an upstream side 420 and a downstream side 422. When difference between the upstream pressure and the downstream pressure is sufficient to open valve wall 430 the valve opens and fluid flows 440 from region 420 to region 422 decreasing the pressure difference. When the pressure difference is no longer great enough to hold valve wall 430 open, valve wall 430 relaxes to a closed configuration. The action of the valve wall 430 produces an audible pressure wave 450, which can be amplified by auscultation devices.

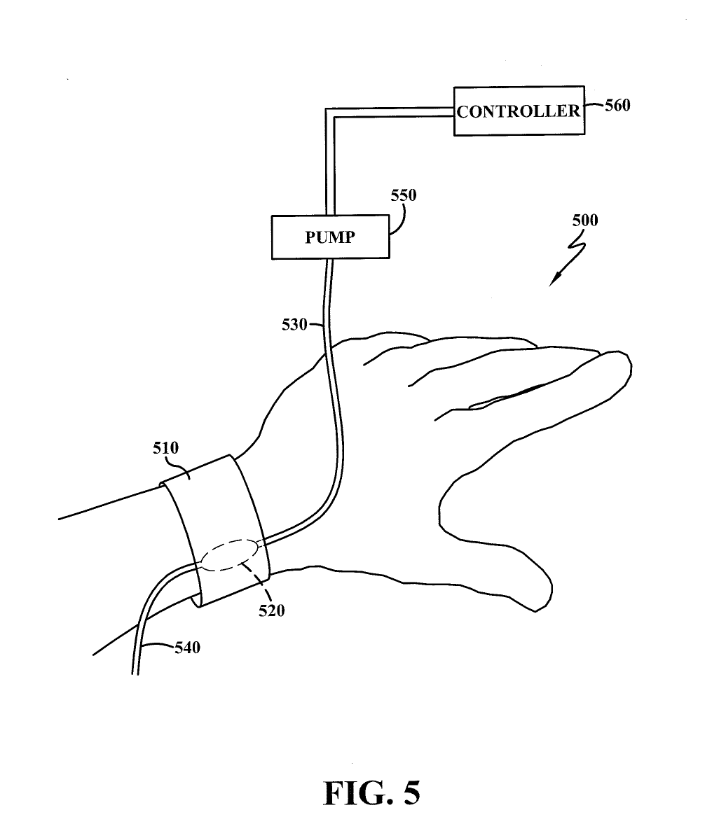

FIG. 5 is a drawing of an embodiment comprising a pulse simulator 500. The simulator 500 is similar to that of FIG. 5 in that it includes a bladder 520 supplied with fluid by an intake tube 530, which is in fluid communication with a pump 550. Fluid exits the bladder through an effluent tube 540. The pump is in controlling electronic communication with a controller unit 560, which is adapted to actuate the pump 550 according to a predetermined pattern. The bladder 520 portion of the embodiment is contained within a wearable wrist strap or band 510, and can be positioned advantageously on a region of the wrist where a natural pulse would normally be detected on a human subject. Thus, a student takes the subject's pulse in the usual manner, but the student only perceives the simulated pulse.

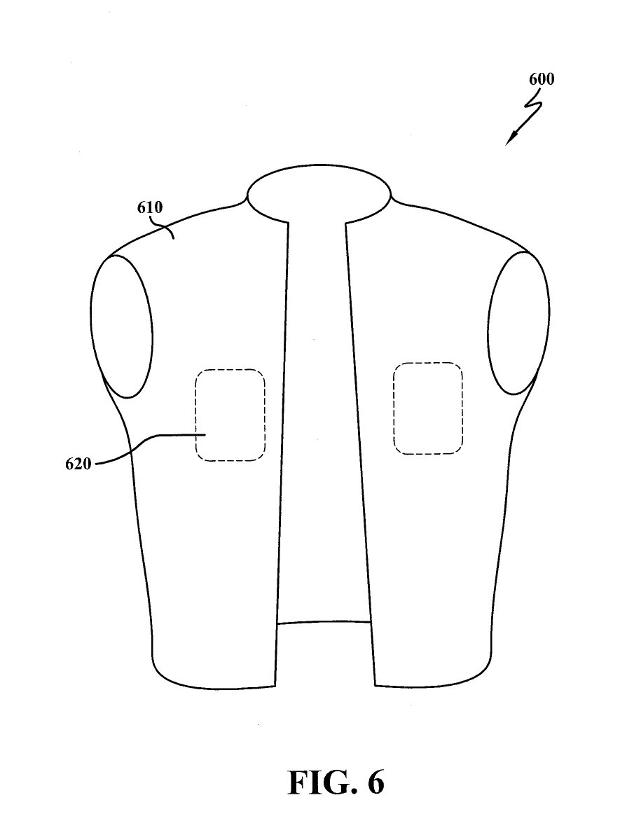

FIG. 6 is an illustration of a wearable embodiment comprising a vest 600. The vest comprises a fitting portion 610 for mounting the embodiment on a human subject, and a pair of simulation units 620 disposed in the chest region. According to some embodiments the simulation units 620 can comprise a pulmonary sounds simulator and/or a heart sounds simulator. Thus a subject wearing the vest can present predetermined symptoms to a student independent of the subject's own physiological state.

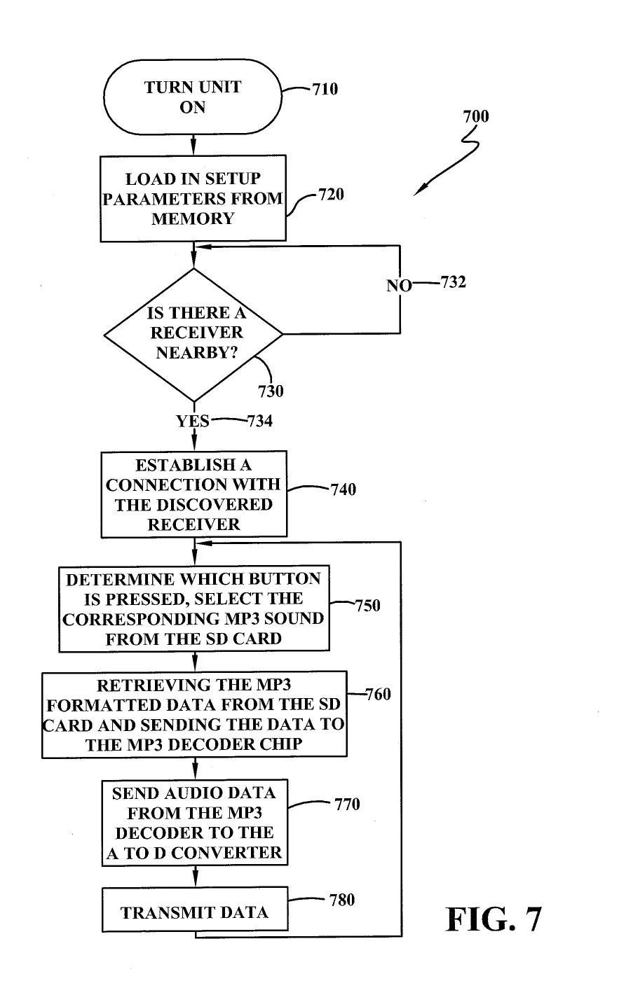

FIG. 7 is a flowchart of a process embodiment 700. According to the embodiment 700 a process for operating a transmitter comprises a first step of turning the unit on 710. Another step comprises loading setup parameters in memory 720. The embodiment 700 also includes checking for a receiver within range of the transmitter 730. According to this embodiment, if a receiver is not found the embodiment continues to check 732 for a receiver until one is found or until the process is otherwise terminated such as by disengaging the power, or by issuing a timeout or termination command. When a receiver is found, the process continues 734 to a next step. According to this embodiment the next step comprises establishing a communications connection between the transmitter and receiver 740. According to this process embodiment 700 the device for carrying out the process comprises a plurality of buttons, each button being associated with a predetermined sound file. After establishing a connection with the receiver an operator can select and push a button to transmit a corresponding sound to the receiver. In this case the sound file comprises an MP3 format. Accordingly, a next step in the process embodiment 700 comprises detecting that a button has been pushed, determining which button, and selecting the corresponding sound file from a memory device 750. A next step includes retrieving the corresponding sound file and sending the file to an MP3 decoder chip 760. The output of the decoder chip can then be directed to an analog to digital converter 770. The digitized sound file can then be transmitted by the transmitter to the receiver 780. According to this embodiment 700, the steps from 750 to 780 can repeat as needed for each communication session between a transmitter and receiver.

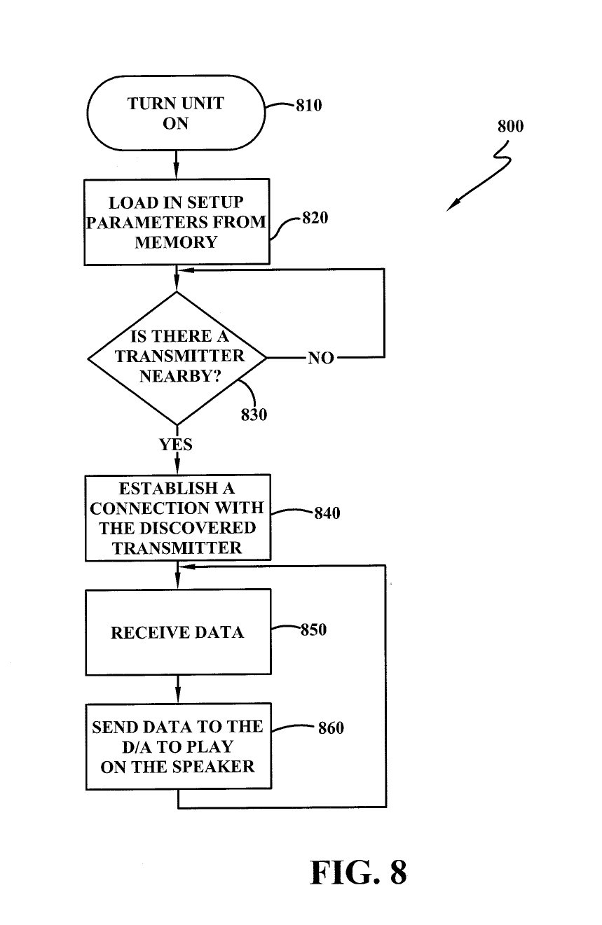

FIG. 8 is a flowchart of a receiver process embodiment 800 of the present invention. According to the embodiment in FIG. 8 a first step in a process for operating a receiver of the present invention includes turning on 810 the receiver unit. A second step includes loading 820 setup parameters in memory. A next step includes determining 830 whether there is a transmitter within range of the receiver. According the embodiment 800 shown in FIG. 8 if no transmitter is detected, the receiver continues attempting to find a transmitter until one is found, or until the process is otherwise terminated such as by turning off power to the unit, or issuing a timeout or termination command. Assuming a transmitter is found in step 840, the next step is establishing 840 a communications connection between the transmitter and receiver. After establishing a connection, a next step according to embodiment 800 is receiving 850 data from the transmitter. According to process embodiment 800 data received from the transmitter can be routed 860 to a digital-to-analog converter. The output of the converter can be directed to a speaker to produce an audible sound corresponding to the MP3 file from which it originated.

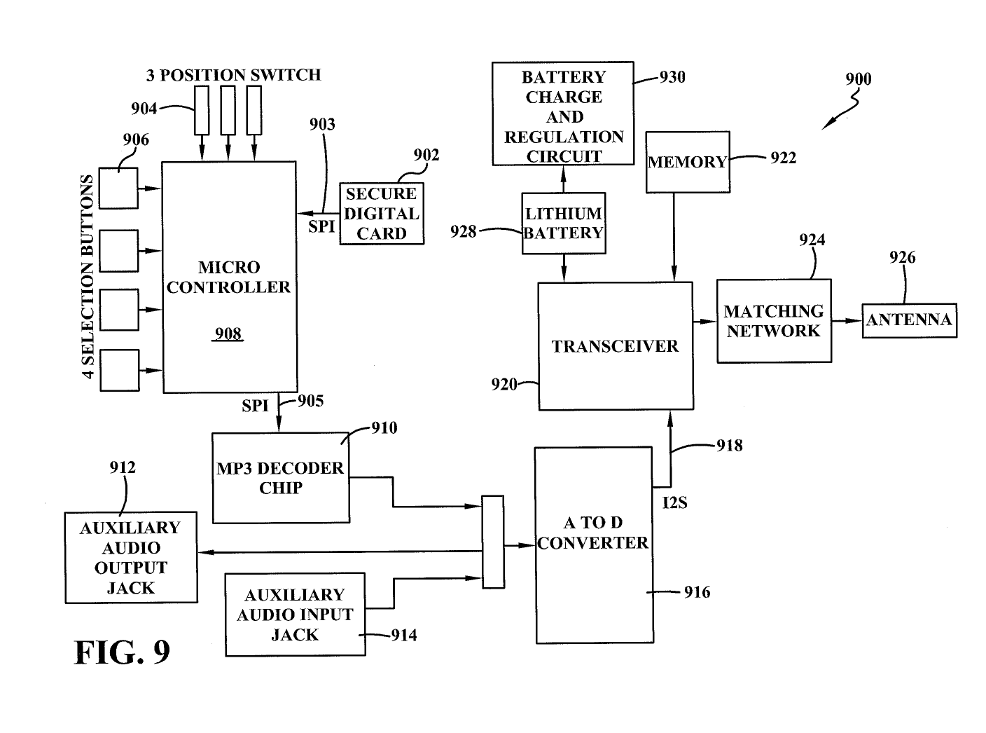

FIG. 9 is a block diagram of a transmitter embodiment 900. According to this embodiment a Secure Digital card 902, i.e. SD card, is adapted to contain electronic data comprising one or more audio files, such as an MP3 file. The card can be removably inserted into an onboard SD card reader. The SD card reader is in electronic communication with a microcontroller 908 through a SPI serial bus 903. The microcontroller 908 is also in electronic communication with a three position switch 904, which is adapted to select a set of one or more sounds or sets thereof. Additionally, the microcontroller 908 is also in electronic communication with a set of four selection buttons 906, which are adapted to select audio files contained on the SD card 902. Thus, when an operator pushes one of the set of four buttons it causes a predetermined audio file to be read and directed to MP3 decoder chip 910 through SPI serial bus 905. The analog output of the MP3 decoder chip 910 is directed to analog-to-digital converter 916, which accepts it as input and directs the resulting digital output to transceiver 920 through I2S serial bus 918. Transceiver 920 is also in bidirectional electronic communication with memory 922. Accordingly, transceiver 920 is adapted to transfer data to and from memory 922. Additionally, according to FIG. 9, transceiver 920 in electrical communication with a lithium battery 928, which provides transceiver 920 with a power source. Furthermore, lithium battery 928 electrically interfaces with transceiver 920 through battery charge and regulation circuit 930 which is adapted to extract electrical power from battery 928 and provide it to transceiver 920 according to predetermined criteria. According to some embodiments regulation circuit 930 is also adapted to regulate battery recharging processes. Finally, transceiver 920 is in electronic communication with a matching network 924, which is adapted to match the transceiver's 920 output impedance with the input impedance of a receiver. Matching network 924 then communicates the electronic signal to broadcasting antenna 926, which is adapted to broadcast the MP3 audio file.

According to FIG. 9 embodiment 900 also includes auxiliary audio output jack 912, which is adapted to receive signals from MP3 decoder chip 910 and direct such signals, or a portion thereof, to an external circuit. Further according to FIG. 9, embodiment 900 includes auxiliary audio input jack 914. Therefore, embodiment 900 is adapted to receive audio data from sources other than an SD card, and in formats other than MP3. In some embodiments plugging an audio source into audio input jack 914 causes the MP3 layer to be disconnected, and only the audio streaming from jack 914 is transmitted.

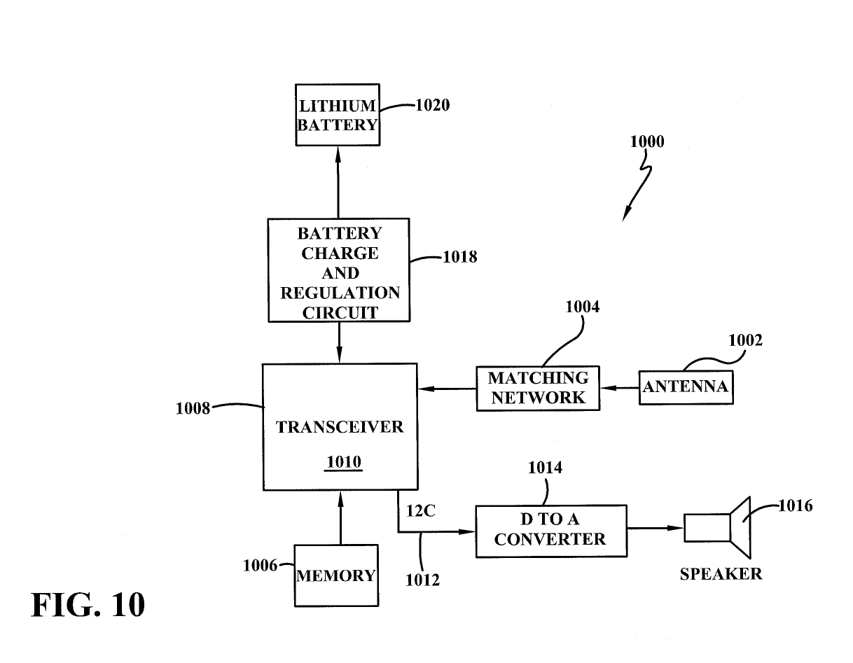

FIG. 10 is a block diagram of a receiver embodiment 1000. Receiver 1000 includes a receiving antenna 1002, which is in electronic communication with matching network 1004. Matching network 1004 is adapted to match the impedance of receiver 1000 to the impedance of transmitter 900. Matching network 1004 is also in electronic communication with transceiver 1010 and is adapted to communicate received signals to transceiver 1010. The output of transceiver 1010 can be communicated to speaker 1016 through digital-to-analog converter 1014. Transceiver 1010 is also in bidirectional communication with memory 1006. Accordingly, transceiver 1010 can upload data to memory 1006 and/or download data from memory 1006 and direct the data to speaker 1016. In some embodiments memory 1006 is adapted to function as a buffer memory. Transceiver 1010 is in electrical communication with lithium battery 1020, which provides transceiver 1010 with electrical power for operation. Lithium battery 1020 communicates electrical power to transceiver 1010 through battery charge and regulation circuit 1018. Battery charge and regulation circuit 1018 is adapted to extract electrical power from battery 1020 and provide it to transceiver 1010 according to predetermined criteria. According to some embodiments battery charge and regulation circuit 1018 is also adapted to regulate battery recharging processes.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

I/We claim:

1. A medical training device, comprising:
at least one modular simulation component, the component comprising
a mounting member adapted to mount the modular component to a portion of a healthy live subject;
a simulation unit incorporated on or in the mounting member and adapted to mimic one or more physiological attributes; and
at least one controller unit in electronic communication with the simulation unit and adapted to control the operation of the simulation unit, wherein the controller unit can be onboard the modular simulation component or disposed remotely from the modular simulation component.

2. The device of claim 1, wherein the mounting member comprises one or more of a sleeve, sock, stocking, girdle, shirt, vest, mitten, glove, adhesive sheet, strap, band, harness, belt, tie, or tether.

3. The device of claim 1, wherein the mounting member comprises a material selected from one or more of thermoform polymers, thermoset polymers, latex, nitrile rubber, carboxylated nitrile rubber, ethylene/methylacrylate copolymers, styrene butadiene rubber, neoprene, natural rubber, silicone, fluoroelastomers, vinylidene fluoride and perfluoro-propylene copolymer, polyurethanes, chlorosulfonated polyethylene, polychloroprene, isoprene, isoneoprene, isobutylene isoprene, acetonitrile butadiene, ethylene proplylene diene monomer, or any derivative, copolymer, blend or combination thereof.

4. The device of claim 1, wherein the mounting member comprises one or more portions made from a woven fabric, nonwoven fabric, or calendared sheet, and wherein the one or more portions can be assembled by sewing, fusing, bonding, gluing, riveting or any combination thereof.

5. The device of claim 1, wherein the simulation unit comprises a component selected from one or more of a speaker, an elastomeric bladder, a one-way valve, a pump, an electroactive polymer, or any combination thereof.

6. The device of claim 1, wherein the one or more physiological attributes includes blood pressure, blood flow, jugular pulses, venous pulses, heart beats, pathological heart sounds, healthy heart sounds, heart murmurs, pulmonary sounds, body heat, tissue exudates, internal bleeding, external bleeding, skin discoloration, eye discoloration, pupillary size, muscle tone, reflexes, or any combination thereof.

7. The device of claim 1, wherein the device comprises a plurality of modules for simulating physiological attributes.

8. The device of claim 7, wherein two or more of the plurality of modules are in bidirectional electronic communication with a common controller unit, the common controller unit being adapted to transmit controlling signals to the two or more modules, and wherein the two or more modules are adapted to transmit data to the common controller.

9. The device of claim 8, wherein the common controller unit is adapted to adjust the operation of the means for simulating in accordance with data received from another module.

10. The device of claim 1, wherein the at least one modular component further comprises at least one sensor for detecting human interaction with the module including one or more of injections, cuts, punctures, compression, or electric shock, wherein the at least one module is adapted to transmit data from the at least one sensor to the controller unit.

11. The device of claim 10, wherein the common controller unit is adapted to transmit control signals to a predetermined module in response to data transmitted from the at least one sensor to the controller unit.

12. The medical training device of claim comprising a mannequin.

13. A medical training device, comprising:
at least one modular simulation component, the component comprising
a means for mounting the modular component to a portion of a healthy live subject
a means for simulating one or more physiological attributes; and
a means for controlling the simulation.

14. A process for training medical personnel, comprising the steps of:
causing a live subject or mannequin to mimic at least one predetermined physiological attribute; and
electronically controlling the at least one mimicked physiological attribute.

15. The process of claim 14, wherein the step of causing further comprises transmitting one or more control signals from a controller unit to a simulation unit.

16. The process of claim 15, wherein the step of transmitting further comprises wirelessly transmitting at least one control signal from a remote controller unit to a simulation unit disposed on the live subject.

17. The process of claim 14, wherein the step of causing further comprises using instructions provided by a computer program or by human interaction to control the simulation.

18. The process of claim 17, wherein the human interaction comprises interaction of a student, a teacher and/or the live subject with the simulation unit.

19. The process of claim 14, wherein the at least one physiological attribute comprises one or more of blood pressure, blood flow, jugular pulses, venous pulses, heart beats, pathological heart sounds, healthy heart sounds, heart murmurs, pulmonary sounds, body heat, tissue exudates, internal bleeding, external bleeding, skin discoloration, eye discoloration, pupillary size, muscle tone, reflexes, or any combination thereof.
